(19) United States
(12) Patent Application Publication
(10) Pub. No.: US 2024/0368383 A1
(43) Pub. Date: Nov. 7, 2024

(54) SULFUR-CROSSLINKABLE RUBBER-COATING MIXTURE, AND PNEUMATIC VEHICLE TYRE

(71) Applicant: Continental Reifen Deutschland GmbH, Hannover (DE)

(72) Inventors: Christoph Eichhorst, Hanau (DE); Joseph Guardalabene, Hannover (DE)

(73) Assignee: Continental Reifen Deutschland GmbH, Hannover (DE)

(21) Appl. No.: 18/689,297

(22) PCT Filed: Aug. 15, 2022
(86) PCT No.: PCT/DE2022/200185

§ 371 Date: Mar. 5, 2024

(30) Foreign Application Priority Data
Sep. 6, 2021 (DE) 10 2021 209 765.0

(51) Int. Cl. C08L 7/00; B60C 1/00; C08K 5/47

(52) U.S. Cl. CPC C08L 7/00; C08K 5/47; B60C 2001/0066

(57) ABSTRACT

A sulfur-crosslinkable rubberization mixture for metallic strength members which contains 0.25 to 5 phr (parts by weight, based on 100 parts by weight of the total rubbers in the mixture) of at least one novolac resin which comprises alkylurethane units and is produced by reaction of a phenolic compound, an aldehyde and a carbamate resin, wherein the carbamate resin is produced by reaction of alkylurethane with an aldehyde, and 0.5 to 3 phr of at least one sulfenimide accelerator. Also provided is a pneumatic vehicle tire which includes at least one such sulfur-crosslinked rubberization mixture.

### CROSS-REFERENCE TO RELATED APPLICATIONS

The present application is a National Stage Application under 35 U.S.C. § 371 of International Patent Application No. PCT/DE2022/200185 filed on Aug. 15, 2022, and claims priority from German Patent Application No. 10 2021 209 765.0 filed on Sep. 6, 2021, the disclosures of which are herein incorporated by reference in their entireties.

### TECHNICAL FIELD

The invention relates to a sulfur-crosslinkable rubberization mixture for metallic strength members which contains at least one novolac resin and at least one sulfenimide accelerator. The invention further relates to a pneumatic vehicle tire which comprises at least one such sulfur-crosslinked rubberization mixture.

### BACKGROUND

The use of methylene acceptor-methylene donor pairs as adhesive systems in the mixtures is known for rubberization mixtures for metallic strength members, in particular brass-plated steel cord. In the so-called direct adhesion process for brass-plated steel cord the rubberization mixture contains for example cobalt salts and a resorcinol-formaldehyde-silica system, wherein the formaldehyde (methylene donor) generally derives from formaldehyde donors such as etherified melamine resins. Etherified melamine resins include, for example, hexamethoxymethylmelamine (HMMM) and hexamethylenetetramine (HMT). Employed methylene acceptors include resorcinol and resorcinol equivalents or precondensates thereof as well as other phenols. The methylene donor and the methylene acceptor form a resin during the vulcanization process. In addition to the sulfur network a second network based on methylene donor and methylene acceptor, which enters into adhesive interaction with the surface of the strength member, is formed. Adhesion is also further improved through the use of reinforcer resins and the mixtures should contain a lot of sulfur and less accelerator to allow sufficient mechanical keying with the steel cord surface.

In addition to resorcinol, special resins such as for example novolac resins are known as methylene acceptors in rubberization mixtures.

U.S. Pat. No. 6,120,911 discloses cobalt-containing rubberization mixtures for metallic strength members containing a cashew nut-modified novolac resin and a sulfenimide accelerator, namely N-tert-butyl-2-benzothiazolesulfenimide (TBSI).

US 2010/0200141 A1 describes cobalt-containing rubberization mixtures for metallic strength members containing N-tert-butyl-2-benzothiazolesulfenimide (TBSI) as vulcanization accelerator.

EP 2 432 810 B1 relates to adhesion-improving rubberization mixtures for rubber articles containing at least one novolac resin which comprises alkylurethane units and is produced by reaction of a phenolic compound, an aldehyde and a carbamate resin, wherein the carbamate resin is produced by reaction of alkylurethane with an aldehyde, and at least one etherified melamine resin. The mixtures should feature good hardness, tensile strength and adhesion while dispensing with resorcinol-based systems which are hazardous to health and the environment. The mixtures described in EP 2 432 810 B1 contain the sulfenamide accelerators N-tert-butyl-2-benzothiazolesulfenamide (TBBS) and N,N-dicyclohexyl-2-benzothiazolesulfenamide (DCBS) as vulcanization accelerators.

### SUMMARY

It is an object of the present invention to provide a sulfur-crosslinkable rubberization mixture for metallic strength members which is improved in terms of adhesion properties after aging and thus results in an improvement in the durability of the reinforced rubber products.

The object is achieved in accordance with the invention when the rubberization mixture contains
0.25 to 5 phr (parts by weight, based on 100 parts by weight of the total rubbers in the mixture) of at least one novolac resin which comprises alkylurethane units and is produced by reaction of a phenolic compound, an aldehyde and a carbamate resin, wherein the carbamate resin is produced by reaction of alkylurethane with an aldehyde, and
0.5 to 3 phr of at least one sulfenimide accelerator.

The unit “phr” (parts per hundred parts of rubber by weight) used in this document is the standard unit of quantity for mixture recipes in the rubber industry. The dosage of the parts by weight of the individual substances is always based on 100 parts by weight of the total mass of all rubbers present in the mixture. The mass of all rubbers present in the mixture sums to 100.

It has surprisingly been found that the combination of a special novolac resin with a sulfenimide accelerator in the specified amounts makes it possible to obtain a rubberization mixture which exhibits good adhesion to the strength member even after aging.

The use of a sulfenimide accelerator also makes it possible to dispense with the use of sulfenamide accelerators, some of which are classed as hazardous to health.

The rubberization mixture contains 0.25 to 5 phr, preferably 1 to 4 phr, of at least one novolac resin which comprises alkylurethane units and is produced by reaction of a phenolic compound, an aldehyde and a carbamate resin, wherein the carbamate resin is produced by reaction of alkylurethane with an aldehyde. It is also possible to employ two or more of such resins.

The novolac resin is produced by reaction of a phenolic compound with an aldehyde and a carbamate resin. The phenolic compound may be selected from the group consisting of phenol, o-, m- and p-cresol and o-, m- and p-monoalkylphenols with alkyl radicals having up to 18 carbon atoms. The phenolic compound is preferably phenol. The aldehyde may be selected from the group consisting of formaldehyde, acetaldehyde, propionaldehyde, butyraldehyde and isobutyraldehyde. The aldehyde is preferably formaldehyde.

The carbamate resin is produced by reaction of alkylurethane with an aldehyde. The alkylurethane may be selected from the group consisting of ethylurethane, butylurethane, 2-ethylhexylurethane and decylurethane. The alkylurethane is preferably butylurethane.

The aldehyde for the carbamate resin may be selected from the group consisting of formaldehyde, acetaldehyde, propionaldehyde, butyraldehyde and isobutyraldehyde. The aldehyde is preferably formaldehyde.

The aldehydes for the novolac resin and the carbamate resin may be identical or different aldehydes.

The rubberization mixture preferably employs a novolac resin produced from phenol, formaldehyde and a carbamate resin made from butylurethane and formaldehyde (butylcarbamate-functionalized phenol-formaldehyde resin).

The rubberization mixture according to the invention contains 0.5 to 3 phr, preferably 1 to 2 phr, of at least one sulfenimide accelerator. Sulfenimide accelerators are vulcanization accelerators based on primary amines. By contrast, sulfenamide accelerators such as DCBS (N,N′-dicyclohexyl-2-benzothiazolesulfenamide) or MBS (N-oxydiethylene-2-benzothiazolesulfenamide) are based on secondary amines. The mixture may contain one or more sulfenimide accelerators.

For particularly good aging stability of the strength member-rubber adhesion even in the presence of oxygen the sulfenimide accelerator is N-tert-butyl-2-benzothiazolesulfenimide (TBSI, IUPAC name: N,N-bis(1,3-benzothiazol-2-ylsulfanyl)-2-methylpropan-2-amine).

In a preferred development of the invention the rubberization mixture contains 1 to 8 phr of at least one etherified melamine resin, preferably hexamethoxymethylmelamine (HMMM) and/or hexamethylenetetramine (HMT). This allows the adhesion between rubberization mixture and strength member to be further improved. The etherified melamine resin is particularly preferably hexamethoxymethylmelamine (HMMM). This is a customary commercially available melamine resin which forms a good resin network. HMMM is employed as a technical grade product for example—often on an inert carrier—with a degree of methylation of <6.

The rubberization mixture according to the invention may contain 1 to 10 phr of resorcinol and/or resorcinol-based methylene acceptors. To avoid processing-related disadvantages and having regard to ecological aspects it has proven advantageous for the rubberization mixture to be substantially free from resorcinol. Resorcinol and resorcinol-based methylene acceptors have disadvantages with regard to occupational safety and environmental protection.

For a further improvement in adhesion between strength member and rubberization it has proven advantageous for the rubberization mixture to contain at least one organic cobalt salt. The organic cobalt salts are typically used in amounts of 0.2 to 2 phr. Cobalt salts that may be used include for example cobalt stearate, borate, borate-alkanoates, naphthenate, rhodinate, octoate, adipate etc.

It is preferable when the metallic strength members are brass-plated steel cord. Through formation of copper sulfide dendrites the brass surface ensures good chemical and mechanical keying with the adjacent rubberization mixture.

The sulfur-crosslinkable rubberization mixture contains further constituents customary in the rubber industry, in particular at least one rubber.

Employable rubbers include diene rubbers. Diene rubbers include all rubbers having an unsaturated carbon chain which at least partially derive from conjugated dienes.

The rubberization mixture may comprise polyisoprene (IR, NR) as diene rubber. This may be either cis-1,4-polyisoprene or 3,4-polyisoprene. Preference is given, however, to the use of cis-1,4-polyisoprenes with a cis-1,4 content >90% by weight. Such a polyisoprene is firstly obtainable by stereospecific polymerization in solution with Ziegler-Natta catalysts or using finely divided lithium alkyls. Secondly, natural rubber (NR) is one such cis-1,4-polyisoprene, the cis-1,4 content in natural rubber being greater than 99% by weight. Natural rubber is understood to mean rubber that can be obtained by harvesting from sources such as rubber trees (Hevea brasiliensis) or non-rubber tree sources (for example guayule or dandelion (e.g. Taraxacum koksaghyz)).

If the rubber mixture contains polybutadiene (BR) as the diene rubber this may be cis-1,4-polybutadiene. Preference is given to the use of cis-1,4-polybutadiene with a cis-1,4 content greater than 90% by weight, which is producible, for example, by solution polymerization in the presence of rare earth catalysts.

Further employable diene rubbers include vinyl-polybutadienes and styrene-butadiene copolymers. The vinyl-polybutadienes and styrene-butadiene copolymers may be solution-polymerized (styrene)-butadiene copolymers (S—(S)BR) having a styrene content, based on the polymer, of about 0% to 45% by weight and a vinyl content (content of 1,2-bonded butadiene, based on the total polymer) of 10% to 90% by weight, which may be produced using lithium alkyls in organic solvent for example. The S—(S)BR may also be coupled and endgroup-modified. However, it is also possible to employ emulsion-polymerized styrene-butadiene copolymers (E-SBR) and mixtures of E-SBR and S—(S)BR. The styrene content of the E-SBR is about 15% to 50% by weight, and it is possible to use the products known from the prior art that have been obtained by copolymerization of styrene and 1,3-butadiene in aqueous emulsion.

The diene rubbers used in the mixture, especially the styrene-butadiene copolymers, can also be used in partly or fully functionalized form. The functionalization can be effected with groups which can interact with the fillers used, especially with fillers bearing OH groups. These may be for example functionalizations with hydroxyl groups and/or epoxy groups and/or siloxane groups and/or amino groups and/or phthalocyanine groups and/or carboxy groups and/or silane sulfide groups. Alternatively or in addition the diene rubbers may also be coupled.

However, in addition to the recited diene rubbers the mixture may also contain other rubber types such as for example styrene-isoprene-butadiene terpolymer, butyl rubber, halobutyl rubber or ethylene-propylene-diene rubber (EPDM).

Regenerate (reclaim) may also be added to the rubberization mixture as a processing aid and to make the mixture more cost-effective.

The rubberization mixture may comprise different fillers, such as carbon blacks, silicas, aluminosilicates, chalk, starch, magnesium oxide, titanium dioxide or rubber gels, in customary amounts, where the fillers may be used in combination.

If carbon black is used in the rubber mixture the types employed are preferably those having a CTAB surface area (to ASTM D 3765) of more than 30 m²/g. These are readily incorporable and ensure low heat buildup.

If silicas are present in the mixture these may be the silicas customary for tire rubber mixtures. It is particularly preferable to employ a finely divided, precipitated silica having a CTAB surface area (to ASTM D 3765) of 30 to 350 m²/g, preferably of 110 to 250 m²/g. Employable silicas include both conventional silicas, such as those of the VN3 type (trade name) from Evonik, or highly dispersible silicas known as HD silicas (e.g. Ultrasil 7000 from Evonik).

If the rubberization mixture contains silica or other polar fillers the mixture may be admixed with silane coupling agents to improve processability and to bind the polar filler to the rubber. The silane coupling agents react with the surface silanol groups of the silica or other polar groups during the mixing of the rubber/the rubber mixture (in situ) or in the context of a pretreatment (premodification) even before addition of the filler to the rubber. Silane coupling agents that may be used here include any silane coupling agents known to those skilled in the art for use in rubber mixtures. Such coupling agents known from the prior art are bifunctional organosilanes having at least one alkoxy, cycloalkoxy or phenoxy group as a leaving group on the silicon atom and having, as another functionality, a group that, after cleavage if necessary, can enter into a chemical reaction with the double bonds of the polymer. The latter group may for example comprise the following chemical groups: —SCN, —SH, —NH₂ or —Sₓ— (with x=2-8). Silane coupling agents that may be used thus include, for example, 3-mercaptopropyltriethoxysilane, 3-thiocyanatopropyltrimethoxysilane or 3,3′-bis(triethoxysilylpropyl) polysulfides having 2 to 8 sulfur atoms, for example 3,3′-bis(triethoxysilylpropyl) tetrasulfide (TESPT), the corresponding disulfide, or else mixtures of the sulfides having 1 to 8 sulfur atoms with different contents of the various sulfides. The silane coupling agents may also be added here as a mixture with industrial carbon black, for example TESPT to carbon black (trade name: X50S from Evonik). Blocked mercaptosilanes as known for example from WO 99/09036 may also be used as a silane coupling agent. It is also possible to use silanes as described in WO 2008/083241 A1, WO 2008/083242 A1, WO 2008/083243 A1 and WO 2008/083244 A1. It is possible to use, for example, silanes which are sold under the NXT name in a number of variants by Momentive, USA, or those that are sold under the VP Si 363 name by Evonik Industries. Also usable are “silated core polysulfides” (SCPs, polysulfides with a silylated core), which are described, for example, in US 20080161477 A1 and EP 2 114 961 B1.

The rubberization mixture according to the invention may further contain customary additives in typical weight fractions. These additives include plasticizers, for example glycerides, factices, hydrocarbon resins, aromatic, naphthenic or paraffinic mineral oil plasticizers (for example MES (mild extraction solvate) or TDAE (treated distillate aromatic extract)), oils based on renewable raw materials (for example rapeseed oil, terpene oils (for example orange oils) or factices), so-called BTL oils (as disclosed in DE 10 2008 037714 A1) or liquid polymers (for example liquid polybutadiene); aging inhibitors, for example N-phenyl-N′-(1,3-dimethylbutyl)-p-phenylenediamine (6PPD), N-isopropyl-N′-phenyl-p-phenylenediamine (IPPD), 2,2,4-trimethyl-1,2-dihydroquinoline (TMQ) and other substances, as known for example from J. Schnetger, Lexikon der Kautschuktechnik, 2nd edition, Hüthig Buch Verlag, Heidelberg, 1991, pages 42-48, activators, for example zinc oxide and fatty acids (for example stearic acid), waxes, tackifier resins, for example hydrocarbon resins and rosin, and mastication aids, for example 2,2′-dibenzamidodiphenyldisulfide (DBD).

The vulcanization is performed in the presence of sulfur and/or sulfur donors, and some sulfur donors can simultaneously act as vulcanization accelerators. Sulfur or sulfur donors are added to the rubberization mixture in the amounts commonly used by those skilled in the art (0.4 to 8 phr) in the last mixing step.

In addition to the sulfenimide accelerators the rubberization mixture may also contain further vulcanization-influencing substances such as further vulcanization accelerators, vulcanization retarders and vulcanization activators in customary amounts. It is preferable when the rubberization mixture contains less than 0.5 phr of other vulcanization accelerators in addition to the sulfenimide accelerators.

Production of the rubberization mixture according to the invention is carried out in conventional fashion, generally by initially producing a base mixture containing all the constituents with the exception of the vulcanization system (sulfur and vulcanization-influencing substances) in one or more mixing stages and subsequently producing the finished mixture by adding the vulcanization system. The mixture is then subjected to further processing.

The rubberization mixture may be employed in a very wide variety of rubber products containing strength members. These rubber products may include for example drive belts, conveyor belts, hoses, rubberized fabrics or air springs.

The rubberization mixture is preferably employed in pneumatic vehicle tires.

The rubberization mixture may be employed for rubberizing a very wide variety of different tire components comprising metallic strength members, such as the bead core, the bead covers, the bead reinforcers, the belt, the carcass or the belt bandages, it also being possible to provide a plurality of components within a tire with the mixture according to the invention. The production of the pneumatic vehicle tires according to the invention is carried out according to processes known to those skilled in the art.

It is preferable when the rubberization mixture is employed as a belt rubberization mixture, where the good adhesion values between strength member and rubberization mixture, even after aging, result in a high service life of the pneumatic vehicle tire.

The invention comprises all advantageous embodiments which are reflected in the claims inter alia. The invention especially also comprises embodiments which result from a combination of different features, for example of constituents of the rubberization mixture, with different levels of preference for these features so that the invention also comprises a combination of a first feature described as “preferred” or described in the context of an advantageous embodiment with a further feature described for example as “particularly preferred”.

### DETAILED DESCRIPTION

The invention shall now be more particularly elucidated with reference to the table which follows.

Table 1 shows mixtures for a rubberization of steel cord where different vulcanization accelerators (DCBS and TBSI) and different novolac resins (phenol-formaldehyde resins with or without carbamate functionalization according to the invention) are employed.

Mixture production was carried out under customary conditions to produce a base mixture and subsequently the finished mixture in a laboratory tangential mixer.

The mixtures were used to produce test specimens by optimal vulcanization under pressure at 160° C., and these test specimens were used to determine material properties typical for the rubber industry by the test methods specified hereinafter.
Shore A hardness at room temperature to DIN ISO 7619-1
Rebound resilience at room temperature to DIN 53 512
Stress at 300% elongation at room temperature to DIN 53 504
Breaking elongation at room temperature to DIN 53504

In addition, the mixtures from table 1 were used to undertake adhesion experiments on brass-plated steel cord (1+5×0.4 HT) to ASTM 2229/D1871 without aging and after aging in oxygen at 70° C. for two days (vulcanization: 30 min, 150° C., embedding length in the rubberization mixture: 10 mm, pull-out speed: 125 mm/min). The pull-out force and coverage were determined.

For all determined properties the measured value for mixture 1 was defined as 100%; the values of the other mixtures were based on mixture 1.

TABLE 1

| Constituents | Unit | 1 | 2 | 3 | 4 | 5 | 6 |
|---|---|---|---|---|---|---|---|
| Natural rubber | phr | 80 | 80 | 80 | 80 | 80 | 80 |
| Polybutadiene | phr | 20 | 20 | 20 | 20 | 20 | 20 |
| Silica | phr | 60 | 60 | 60 | 60 | 60 | 60 |
| Plasticizers, processing aids, | phr | 12.65 | 12.65 | 12.65 | 12.65 | 12.65 | 12.65 |
| silane coupling agent | | | | | | | |
| Zinc oxide | phr | 8 | 8 | 8 | 8 | 8 | 8 |
| Aging inhibitor | phr | 4.6 | 4.6 | 4.6 | 4.6 | 4.6 | 4.6 |
| Cobalt borate alkanoate | phr | 0.4 | 0.4 | 0.4 | 0.4 | 0.4 | 0.4 |
| HMMM^{a)} | phr | 3.85 | 3.85 | 3.85 | 3.85 | 3.85 | 3.85 |
| Resorcinol | phr | 2.5 | — | — | 2.5 | — | — |
| Phenol-formaldehyde resin^{b)} | phr | — | 2.5 | — | — | 2.5 | — |
| Butylcarbamate-functionalized | phr | — | — | 2.5 | — | — | 2.5 |
| phenol-formaldehyde resin^{c)} | | | | | | | |
| DCBS | phr | 1.5 | 1.5 | 1.5 | — | — | — |
| TBSI | phr | — | — | — | 1.5 | 1.5 | 1.5 |
| Sulfur (67%) | phr | 6.45 | 6.45 | 6.45 | 6.45 | 6.45 | 6.45 |
| Properties | | | | | | | |
| Hardness at RT | % | 100 | 100 | 101 | 100 | 99 | 98 |
| Rebound resilience at RT | % | 100 | 98 | 100 | 100 | 98 | 100 |
| Tensile strength at RT | % | 100 | 98 | 99 | 107 | 92 | 91 |
| Breaking elongation | % | 100 | 119 | 97 | 93 | 99 | 101 |
| Pull-out force (unaged) | % | 100 | 105 | 98 | 93 | 104 | 103 |
| Pull-out force (oxygen-aged) | % | 100 | 106 | 97 | 99 | 104 | 110 |
| Coverage (unaged) | % | 100 | 96 | 102 | 101 | 99 | 100 |
| Coverage (oxygen-aged) | % | 100 | 99 | 100 | 100 | 100 | 100 |

^{a)}Hexamethoxymethylmelamine 65% on silica
^{b)}Elaztobond ® A250LP, SI Group, USA
^{c)}Alnovol ® PN 760/Past, Allnex Netherlands B. V.

The inventive steel cord rubberizations 6 of table 1 show a marked improvement in adhesion properties which is improved over comparative mixtures 1 to 5 especially after oxygen aging. This improvement only occurs when both the butylcarbamate-functionalized phenol-formaldehyde resin and the TBSI are present in the mixture. The individual measures according to mixtures 3 and 4 and the use of a different phenol-formaldehyde resin without butylcarbamate functionalization according to mixtures 2 and 5 do not lead to such an improvement.

The improvement in adhesion properties ultimately leads to better durability in the rubber products with correspondingly rubberized metallic strength members.

1. A sulfur-crosslinkable rubberization mixture for metallic strength members containing
0.25 to 5 phr (parts by weight, based on 100 parts by weight of the total rubbers in the mixture) of at least one novolac resin which comprises alkylurethane units and is produced by reaction of a phenolic compound, an aldehyde and a carbamate resin, wherein the carbamate resin is produced by reaction of alkylurethane with an aldehyde, and
0.5 to 3 phr of at least one sulfenimide accelerator.

2. The sulfur-crosslinkable rubberization mixture as claimed in claim 1, wherein it contains
1 to 4 phr of at least one novolac resin which comprises alkylurethane units and is produced by reaction of a phenolic compound, an aldehyde and a carbamate resin, wherein the carbamate resin is produced by reaction of alkylurethane with an aldehyde.

3. The sulfur-crosslinkable rubberization mixture as claimed in claim 1, wherein the phenolic compound is phenol.

4. The sulfur-crosslinkable rubberization mixture as claimed in claim 1, wherein the alkylurethane is butylurethane.

5. The sulfur-crosslinkable rubberization mixture as claimed in claim 1, wherein the aldehyde is formaldehyde.

6. The sulfur-crosslinkable rubberization mixture as claimed in claim 1, wherein it contains 1 to 2 phr of at least one sulfenimide accelerator.

7. The sulfur-crosslinkable rubberization mixture as claimed in claim 1, wherein the sulfenimide accelerator is N-tert-butyl-2-benzothiazolesulfenimide (TBSI).

8. The sulfur-crosslinkable rubberization mixture as claimed in claim 1, wherein it contains 1 to 8 phr of at least one etherified melamine resin.

9. The sulfur-crosslinkable rubberization mixture as claimed in claim 1, wherein it contains at least one organic cobalt salt.

10. The sulfur-crosslinkable rubberization mixture as claimed in claim 1, wherein the metallic strength member is a brass-plated steel cord.

11. A pneumatic vehicle tire comprising a sulfur-crosslinked rubberization mixture as claimed in claim 1.

12. The pneumatic vehicle tire as claimed in claim 11, wherein it comprises a belt rubberization composed of the rubberization mixture.
